(19) United States
(12) Patent Application Publication
(10) Pub. No.: US 2024/0351476 A1
(43) Pub. Date: Oct. 24, 2024

(54) SYSTEMS AND METHODS OF FLOODING A WATERCRAFT BATTERY

(71) Applicant: ARC BOAT COMPANY, San Francisco, CA (US)

(72) Inventors: Ryan Cook, San Francisco, CA (US); Robert Binkowski, San Francisco, CA (US); Matthew Mey, San Francisco, CA (US)

(21) Appl. No.: 18/644,245

(22) Filed: Apr. 24, 2024

Related U.S. Application Data
(60) Provisional application No. 63/461,450, filed on Apr. 24, 2023.

(51) Int. Cl. B60L 58/26; B60L 3/00; B60L 58/18; B63B 13/00; B63H 21/17; B63H 21/38; H01M 10/48; H01M 10/613; H01M 10/625; H01M 10/63; H01M 10/6568

(52) U.S. Cl. CPC B60L 58/26; B60L 3/0046; B60L 58/18; B63B 13/00; B63H 21/17; B63H 21/383; H01M 10/486; H01M 10/613; H01M 10/625; H01M 10/63; H01M 10/6568; B60L 2240/545; B60L 2240/547; B60L 2240/549; H01M 2220/20

(57) ABSTRACT

A watercraft comprising a hull, an electric drive, a battery electrically coupled to the electric drive, an intake aperture formed in the hull, and a pump fluidly coupled to the intake aperture by an intake channel positioned between the intake aperture and the pump. The watercraft further includes an outlet channel fluidly coupled to the pump and the battery, and a discharge aperture formed in the hull and fluidly coupled to the battery by a discharge channel positioned between the discharge aperture and the battery.

### CROSS-REFERENCE TO RELATED APPLICATION

The present application claims priority to U.S. Provisional Application No. 63/461,450, filed Apr. 24, 2023, which is incorporated herein by reference in its entirety.

### TECHNICAL FIELD

This disclosure relates to systems for reducing and preventing thermal runaway in batteries for watercraft (e.g., boats) and methods of using the same.

### BACKGROUND

Thermal runaway occurs when more heat than can be withdrawn is generated in a battery cell, leading to further increases in reaction rate and heat generation. Eventually, the amount of generated heat can lead to the combustion of the battery as well as materials in proximity to the battery. Thermal runaway can be initiated by a short circuit within the cell, improper cell use, physical abuse, manufacturing defects, or exposure of the cell to extreme external temperatures. In the case of a battery pack used in an electric vehicle, a severe crash may send multiple cells within the battery pack into thermal runaway.

During a thermal runaway event, a large amount of thermal energy is rapidly released, heating the entire cell. Due to the increased temperature of the cell undergoing thermal runaway, the temperature of adjacent cells within the battery pack will also increase. If the temperature of these adjacent cells is allowed to increase unimpeded, they may also enter into a state of thermal runaway, leading to a cascading effect where the initiation of thermal runaway within a single cell propagates throughout the entire battery pack. As a result, power from the battery pack is interrupted and the system employing the battery pack is more likely to incur extensive collateral damage due to the scale of thermal runaway and the associated release of thermal energy.

A number of approaches in the automotive industry have been employed to either reduce the risk of thermal runaway or reduce the risk of thermal runaway propagation.

### SUMMARY

The disclosure provides, in one aspect, a watercraft comprising a hull, an electric drive, and a battery electrically coupled to the electric drive. The watercraft further includes an intake aperture formed in the hull, a pump fluidly coupled to the intake aperture by an intake channel positioned between the intake aperture and the pump, and an outlet channel fluidly coupled to the pump and the battery. The watercraft further includes a discharge aperture formed in the hull and fluidly coupled to the battery by a discharge channel positioned between the discharge aperture and the battery.

In some embodiments, the watercraft further includes a controller and a sensor coupled to the battery.

In some embodiments, the sensor is positioned within the battery.

In some embodiments, the pump is electrically coupled to the controller and the pump is energized in response to the sensor detecting a failure condition.

In some embodiments, the sensor is a temperature sensor, a voltage sensor, or a current sensor.

In some embodiments, the sensor is one of a plurality of sensors coupled to the battery.

In some embodiments, the battery has a power rating of at least 110 kWh and the pump generates a flow rate of fluid of at least 100 LPM.

In some embodiments, the battery includes an enclosure and a plurality of cells.

In some embodiments, the battery is a first battery and the watercraft further includes a second battery electrically coupled to the electric drive; and wherein the outlet channel is fluidly coupled to the pump, the first battery, and the second battery.

In some embodiments, the watercraft further includes a first valve positioned in the outlet channel between the pump and the first battery, and a second valve positioned in the outlet channel between the pump and the second battery.

In some embodiments, the first valve and the second valve are electrically actuated.

In some embodiments, the first valve is open to flood the first battery while the second valve is closed and the second battery is operational.

The disclosure provides, in one aspect, a watercraft comprising a hull, an electric drive, and a battery electrically coupled to the electric drive. The watercraft further includes an intake aperture formed in the hull, an intake channel positioned between the intake aperture and the battery, a first passive valve positioned in the intake channel, and an actuated valve positioned in the intake channel. The watercraft further includes a discharge aperture formed in the hull, a discharge channel positioned between the battery and the discharge aperture; and a second passive valve positioned in the discharge channel.

In some embodiments, the intake aperture is positioned in a bottom portion of the hull and the discharge aperture is positioned in a side portion of the hull.

In some embodiments, the first passive valve is positioned between the actuated valve and the battery.

In some embodiments, the first passive valve is a burst disc.

The disclosure provides, in one aspect, a method comprising: detecting a failure in a battery positioned within a watercraft; opening a flow channel in fluid communication with the battery; moving water external to the watercraft through the flow channel and into the battery to cool the battery and create heated water; and draining heated water out of the battery.

In some embodiments, detecting the failure in the battery includes determining a temperature in the battery is over a threshold temperature.

In some embodiments, detecting the failure in the battery includes determining a voltage of the battery is outside of a threshold range.

In some embodiments, the method further includes activating a pump; wherein the pump moves water into the battery.

In some embodiments, activating the pump is in response to receiving a user input or automatic in response to detecting the failure.

In some embodiments, opening the flow channel is in response to detecting the failure.

In some embodiments, the method further includes opening a release in response to a pressure within the battery exceeding a threshold pressure.

In some embodiments, draining heated water out of the battery includes moving heated water to a bilge area of the watercraft or discharging heated water from the watercraft.

In some embodiments, the battery is a first battery and the method further includes energizing an electric drive powered by a second battery.

Other aspects of the disclosure will become apparent by consideration of the detailed description and accompanying drawings.

### BRIEF DESCRIPTION OF THE DRAWINGS

These and other features, aspects, and advantages of the present technology will become better understood with regards to the following drawings. The accompanying figures and examples are provided by way of illustration and not by way of limitation.

FIG. 1 is a top view of a watercraft including a battery and an active flood system.

FIG. 2 is a top view of a watercraft including a first battery, a second battery, and an active flood system.

FIG. 3 is a rear view of a watercraft including a battery and a passive flood system.

FIG. 4 is a flowchart of a method for flooding a battery with a flood system.

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The term “coupled,” as used herein, is defined as “connected,” although not necessarily directly, and not necessarily mechanically. The term coupled is to be understood to mean physically, magnetically, chemically, fluidly, electrically, or otherwise coupled, connected or linked and does not exclude the presence of intermediate elements between the coupled elements absent specific contrary language.

As used herein, the terms “controller,” “processor,” and “central processing unit” or “CPU” are used interchangeably and refer to a device that is able to read a program from a computer memory (e.g., ROM or other computer memory) and perform a set of steps according to the program. As used herein, the term “controller” (e.g., a microprocessor, a microcontroller, a processing unit, or other suitable programmable device) can include, among other things, a control unit, an arithmetic logic unit (“ALC”), and a plurality of registers, and can be implemented using a known computer architecture (e.g., a modified Harvard architecture, a von Neumann architecture, etc.). In some embodiments the processor is a microprocessor that can be configured to communicate in a stand-alone and/or a distributed environment, and can be configured to communicate via wired or wireless communications with other processors, where such one or more processor can be configured to operate on one or more processor-controlled devices that can be similar or different devices.

As used herein, the term “memory” is any memory storage and is a non-transitory computer readable medium. The memory can include, for example, a program storage area and the data storage area. The program storage area and the data storage area can include combinations of different types of memory, such as a ROM, a RAM (e.g., DRAM, SDRAM, etc.), EEPROM, flash memory, a hard disk, a SD card, or other suitable magnetic, optical, physical, or electronic memory devices. The processor can be connected to the memory and execute software instructions that are capable of being stored in a RAM of the memory (e.g., during execution), a ROM of the memory (e.g., on a generally permanent bases), or another non-transitory computer readable medium such as another memory or a disc. In some embodiments, the memory includes one or more processor-readable and accessible memory elements and/or components that can be internal to the processor-controlled device, external to the processor-controlled device, and can be accessed via a wired or wireless network. Software included in the implementation of the methods disclosed herein can be stored in the memory. The software includes, for example, firmware, one or more applications, program data, filters, rules, one or more program modules, and other executable instructions. For example, the processor can be configured to retrieve from the memory and execute, among other things, instructions related to the processes and methods described herein. As used herein, the term “computer readable medium” refers to any device or system for storing and providing information (e.g., data and instructions) to a computer processor. Examples of computer readable media include, but are not limited to, DVDs, CDs, hard disk drives, magnetic tape and servers for streaming media over networks, whether local or distant (e.g., cloud-based).

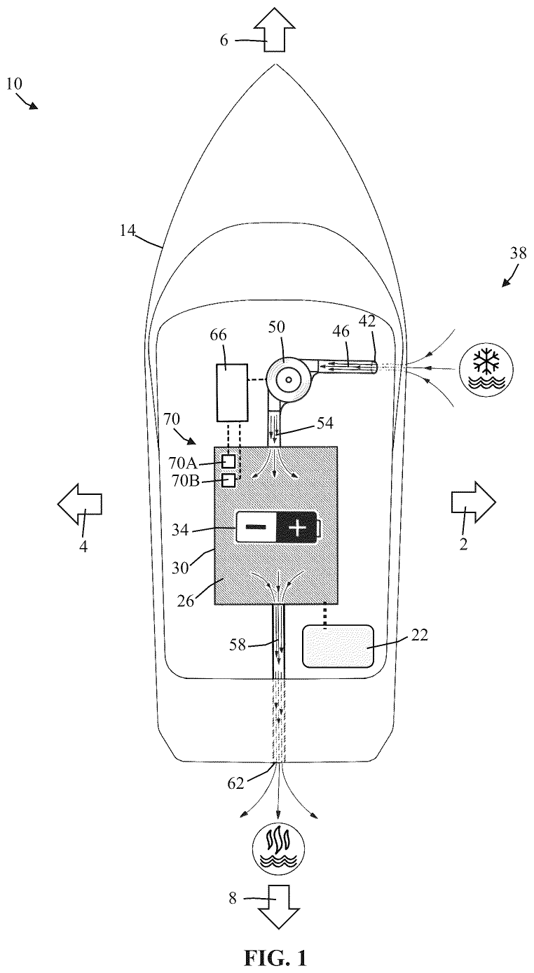

To facilitate the understanding of this disclosure, a number of marine terms are defined below. Terms defined herein have meanings as commonly understood by a person of ordinary skill in the areas relevant to the present disclosure. “Starboard” refers to the right-hand, or driver's, side of the watercraft. “Port” refers to the left-hand, or passenger's, side of the watercraft. “Bow” refers to the front of the watercraft. “Transom” and “stern” refer to the rear of the watercraft. The starboard 2, port 4, bow 6, and stern 8 directions are illustrated in FIG. 1 for reference.

As used herein, the term “failure condition” in reference to a battery refers to a state (e.g., a physical state, an electrical state, a chemical state, etc.) of the battery that is not proper operation. In some embodiments, the “failure condition” is a state of thermal runaway in the battery. In some embodiments, the “failure condition” is a state of the battery that proceeds thermal runaway in the battery.

With reference to FIG. 1, a watercraft 10 includes a hull 14 and is propelled through the water by a propeller that is rotationally driven by an electric drive 22. In some embodiments, the electric drive 22 includes an electric motor (e.g., an induction motor, a synchronous motor, a brushless DC motor, a permanent magnet rotor, an interior permanent magnet motor, a surface permanent magnet motor, a reluctance motor, etc.) and a power converter (e.g., an inverter, a converter, etc.).

The watercraft 10 includes a battery 26 electrically coupled to the electric drive 22. In some embodiments, the battery 26 includes an enclosure 30 (e.g., a housing) and at least one cell 34 positioned within the enclosure 30. In some embodiments, the battery 26 has a power rating of at least 110 kWh.

With continued reference to FIG. 1, the watercraft 10 includes a flood system 38 fluidly coupled to the battery 26. As detailed further herein, the flood system 38 is configured to flood the battery 26 with external water (e.g., the water the watercraft 10 is positioned in). The flood system 38 fills the battery 26 with external water and then discharges the water from the battery 26. The flood system 38 is activated when the battery 26 is, or has, failed and advantageously prevents or reduces the risk of thermal runaway occurring in the battery 26.

With reference to FIG. 1, the flood system 38, in one embodiment, includes an intake aperture 42, an intake channel 46, a pump 50, an outlet channel 54, a discharge channel 58, and a discharge aperture 62. The intake aperture 42 is formed in the hull 14 and is in fluid communication with external water. The discharge aperture 62 is formed in the hull 14 and is in fluid communication with external water. In the illustrated embodiment, the intake aperture 46 is positioned towards the bow (e.g., in the bow direction 6) from the discharge aperture 62.

The pump 50 is fluidly coupled to the intake aperture 42 by the intake channel 46. In other words, the intake channel 46 is positioned between the intake aperture 42 and the pump 50. The pump 50 is fluidly coupled to the battery 26 by the outlet channel 54. In other words, the outlet channel 54 is fluidly coupled to the pump 50 and the battery 26. In the illustrated embodiment, the pump 50 is positioned between the intake channel 46 and the outlet channel 54. The battery 26 is fluidly coupled to the discharge aperture 62 by the discharge channel 58. In other words, the discharge channel 58 is positioned between the discharge aperture 62 and the battery 26. In the illustrated embodiment, the battery 26 is positioned between the outlet channel 54 and the discharge channel 58.

With continued reference to FIG. 1, the watercraft 10 includes a controller 66 (e.g., a processor) electrically coupled to various components of the watercraft 10. In the illustrated embodiment, the watercraft 10 further includes at least one sensor 70 electrically coupled to the controller 66. For example, the sensor 70A and the sensor 70B are coupled to the battery 26. In some embodiments, the watercraft 10 includes a plurality of sensors coupled to the battery 26. In some embodiments, the sensors 70A, 70B are positioned within the battery 26. The at least one sensor 70 may be a temperature sensor (e.g., detecting a battery cell temperature), a voltage sensor (e.g., detecting a battery cell voltage), a current sensor (e.g., detecting battery cell discharge current), or any other type of suitable sensor.

The pump 50 is electrically coupled to the controller 66 and the pump 50 is energized in response to the sensor 70A or the sensor 70B detecting a failure condition. As such, the flood system 38 is an active flood system (e.g., an actively pumping external water through the system). In other words, the flood system 38 is activated in response to the sensors 70 detecting a failure condition in the battery 26.

Advantageously, the flood system 38 mitigates the damage to surrounding structure and systems on the watercraft 10 and keep passengers safe by taking energy being released from the battery 26 and removing it from the watercraft 10. In less severe cases, the flood system 38 prevents deck and surrounding structure of the watercraft 10 from catching fire or melting by limiting the damage to the battery 26. In more severe cases, the flood system 38 limits the severity and increases the time available for passengers to safely disembark the watercraft 10.

As discussed herein, water directly contacts the battery cells and other internal components of the battery. When the battery 26 is flooded by the flood system 38, the plurality of cells 34 within the battery 26 are shorted. As such, the battery 26 is no longer operable or usable after being flooded by the flood system 38. This direct contact of water with the battery distinguishes the flood system 38 disclosed herein from, for example, a conventional liquid-cooled battery where the battery remains operational as a liquid indirectly removes heat from the battery. These conventional liquid-cooling systems do not have the thermal capacity to deal with a thermal runaway condition in the battery. The flood system 38 is a high flow rate system. For example, the pump 50 generates a flow rate sufficient to dissipate the stored energy capacity of the battery 26. In some embodiments, the pump 50 generates a flow rate of fluid of at least 100 liters per minute (LPM) corresponding to a 110 kWh battery.

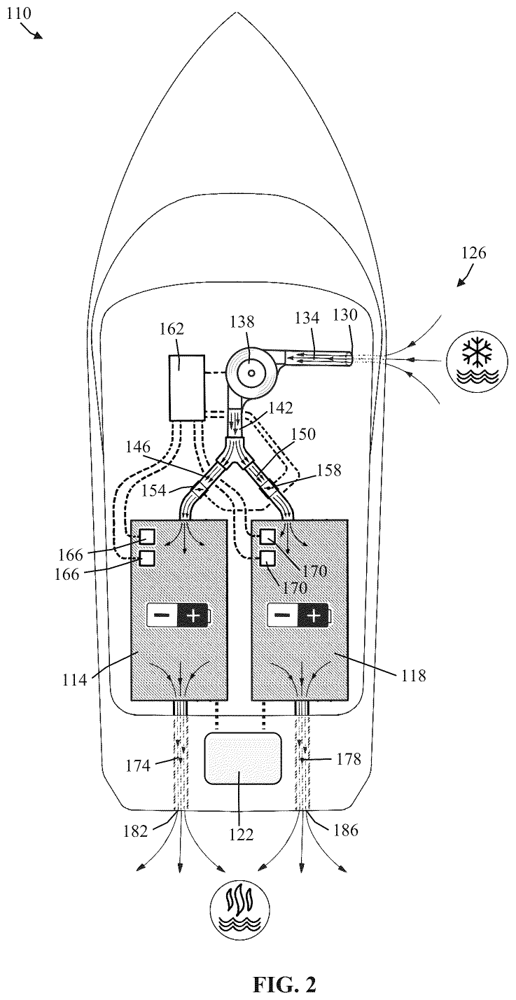

With reference to FIG. 2, a watercraft 110 is similar to the watercraft 10 with differences detailed herein. The watercraft 110 includes a first battery 114 and a second battery 118 electrically coupled to an electric drive 122. The watercraft 110 includes a flood system 126 including an intake aperture 130, an intake channel 134, a pump 138, and an outlet channel 142. The outlet channel 142 includes a first branch 146 fluidly coupled to the first battery 114 and a second branch 150 fluidly coupled to the second battery 118. As such, the outlet channel 142 is fluidly coupled to the pump 138, the first battery 114, and the second battery 118.

With continued reference to FIG. 2, a first valve 154 is positioned in the outlet channel 142 between the pump 138 and the first battery 114. In the illustrated embodiment, the first valve 154 is positioned in the first branch 146. Similarly, a second valve 158 is positioned in the outlet channel 142 between the pump 138 and the second battery 118. In the illustrated embodiment, the second valve 158 is positioned in the second branch 150. In some embodiments, the first valve 154 and the second valve 158 are electrically actuated. In the illustrated embodiment, the first valve 154 and the second valve 158 are electrically coupled to a controller 162. In other words, the controller 162 is configured to actuate, move, or otherwise control the valves 154. 158. In the illustrated embodiment, the controller 162 is electrically coupled to the pump 138 and sensors 166 coupled to the first battery 114 and sensors 170 coupled to the second battery 118

The flood system 126 further includes a first discharge channel 174, a second discharge channel 178, a first discharge aperture 182, and a second discharge aperture 186. As such, heated water from the batteries 114, 118 can be discharge to continue the inflow of fresh cool external water. In the illustrated embodiment, the first battery 114 can be flooded independent of the second battery 118. Likewise, the second battery 118 can be flooded independent of the first battery 114. For example, the first valve 154 can be in an open position to flood the first battery 114 with water, while the second valve 158 is in a closed position and the second battery 118 remains operational. Advantageously, the flood system 126 provides thermal management of a faulty battery while keeping the remaining healthy batteries operational. For example, one battery may be flooded with water by the flood system while another battery is utilized to power the electric drive to continue operation of the watercraft (e.g., a limp-home operation mode). In some embodiments, each battery includes a dedicated flood system that is separate and independent of flood systems for other batteries.

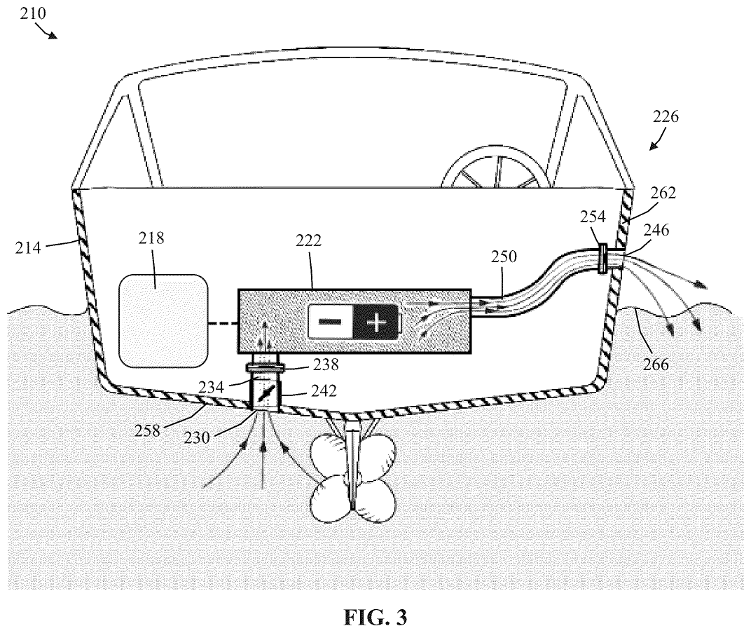

With reference to FIG. 3, a watercraft 210 includes a hull 214, an electric drive 218, and a battery 222 electrically coupled to the electric drive 218. The watercraft 210 includes a flood system 226 fluidly coupled to the battery 222. In the illustrated embodiment, the flood system 226 includes an intake aperture 230, an intake channel 234, a first passive valve 238, an actuated valve 242, a discharge aperture 246, a discharge channel 250, and a second passive valve 254. As detailed further herein, the flood system 226 is a passive flood system (e.g., a flood system that does not actively pump water through the system). In the passive flood system 26, pressure differential is used to create a passive but high flow rate.

The intake aperture 230 is formed in the hull 214. In the illustrated embodiment, the intake aperture 230 is positioned in a bottom portion 258 of the hull 214. The discharge aperture 246 is formed in the hull 214. In the illustrated embodiment, the discharge aperture 246 is positioned in a side portion 262 of the hull 214. In some embodiments, the discharge aperture 246 is positioned above a water line 266. In other words, the discharge aperture 246 is positioned vertically higher than the intake aperture 230 from the frame of reference of FIG. 3.

With continued reference to FIG. 3, the intake channel 234 is positioned between the intake aperture 230 and the battery 222. The first passive valve 238 is positioned in the intake channel 234. In some embodiments, the first passive valve 238 is a burst disc that ruptures in response to the pressure reaching a threshold pressure. The actuated valve 242 is positioned in the intake channel 234. In the illustrated embodiment, the first passive valve 238 is positioned between the actuated valve 242 and the battery 222.

With continued reference to FIG. 3, the discharge channel 250 is positioned between the battery 222 and the discharge aperture 246. The second passive valve 254 is positioned in the discharge channel 250. In some embodiments, the second passive valve 254 is a burst disc. In some embodiments, the passive valves 238, 254 are pressure activated release valves that are suitable for air or water.

In operation, the passive flood system 226 floods the battery 222 with external water without the use of a pump in response to opening of the actuated valve 242. In other words, the actuated valve 242 is opened in response to detecting a failure condition in the battery 222. A water pressure differential drives external water into the intake aperture 230 and through the first passive valve 238. Cooling external water continues to fill the battery 222 and the heated water exits the battery 222 through the second passive valve 254 and out the discharge aperture 246.

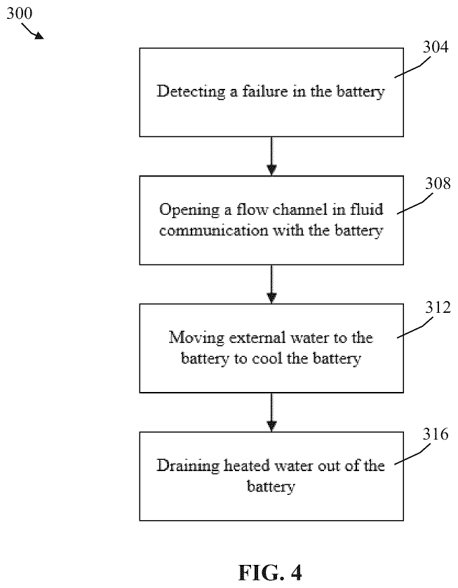

With reference to FIG. 4, a method 300 for flooding a battery with external water is illustrated. The method 300 includes (STEP 304) detecting a failure in a battery positioned within a watercraft. In some embodiments, detecting the failure in the battery includes determining a temperature in the battery is over a threshold temperature. In some embodiments, detecting the failure in the battery includes determining a voltage of the battery is outside of a threshold range. In some embodiments, one or more sensors coupled to the battery are used to detect the failure in the battery.

The method 300 further includes (STEP 308) opening a flow channel in fluid communication with the battery. In some embodiments, opening a flow channel includes opening a valve (e.g., valves 154, 158, 242). In some embodiments, opening the flow channel is in response to detecting the failure in the battery. The method 300 further includes (STEP 312) moving water external to the watercraft through the flow channel and into the battery to cool the battery. In other words, the external water absorbs thermal energy from the battery and becomes heated water. In some embodiments, the method 300 further includes activating a pump (e.g., pump 50, 138) that moves water into the battery. In some embodiments, activating the pump is in response to receiving a user input or automatic in response to detecting the failure.

With continued reference to FIG. 4, the method 300 further includes (STEP 316) draining heated water out of the battery. In some embodiments, draining heated water out of the battery includes moving heated water to a bilge area of the watercraft to be pump out of the watercraft later. In some embodiments, draining heated water out of the battery includes discharging heated water from the watercraft (e.g. draining directly overboard). In some embodiments, the method 300 includes opening a release (e.g., passive valve 238, 254) in response to a pressure within the battery exceeding a threshold pressure.

In some embodiments, the battery is a first battery and the method further includes energizing an electric drive powered by a second battery. In other words, the method 300 includes cooling a first battery in failure while utilizing a second operational battery to power the watercraft.

The systems and methods described herein can be implemented in hardware, software, firmware, or combinations of hardware, software and/or firmware. In some examples, the systems and methods described in this specification may be implemented using a non-transitory computer readable medium storing computer executable instructions that when executed by one or more processors of a computer cause the computer to perform operations. Computer readable media suitable for implementing the systems and methods described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application-specific integrated circuits. In addition, a computer readable medium that implements a system or method described in this specification may be located on a single device or computing platform or may be distributed across multiple devices or computing platforms.

In the illustrated embodiment, the watercraft 10 is a boat. In other embodiments, the watercraft is a fishing boat, a dingy boat, a deck boat, a bowrider boat, a catamaran boat, a cuddy cabin boat, a center console boat, a houseboat, a trawler boat, a cruiser boat, a game boat, a yacht, a personal watercraft boat, a water scooter, a jet-ski, a runabout boat, a jet boat, a wakeboard, a ski boat, a life boat, a pontoon boat, or any suitable motor boat, vessel, craft, or ship.

Although an example is illustrated with respect to an all-electric watercraft, the battery and flood systems described herein can also be used in a conventional motorboat application (e.g., with a gasoline or diesel-powered engine), where a battery is positioned in the watercraft to power auxiliary functions (e.g., controls, lights, speakers, etc.).

Various features and advantages are set forth in the following claims.

What is claimed is:

1. A watercraft comprising:
a hull;
an electric drive;
a battery electrically coupled to the electric drive;
an intake aperture formed in the hull;
a pump fluidly coupled to the intake aperture by an intake channel positioned between the intake aperture and the pump;
an outlet channel fluidly coupled to the pump and the battery; and
a discharge aperture formed in the hull and fluidly coupled to the battery by a discharge channel positioned between the discharge aperture and the battery.

2. The watercraft of claim 1, further comprising a controller and a sensor coupled to the battery.

3. The watercraft of claim 2, wherein the sensor is positioned within the battery.

4. The watercraft of claim 2, wherein the pump is electrically coupled to the controller and the pump is energized in response to the sensor detecting a failure condition.

5. The watercraft of claim 4, wherein the sensor is a temperature sensor, a voltage sensor, or a current sensor.

6. The watercraft of claim 1, wherein the sensor is one of a plurality of sensors coupled to the battery.

7. The watercraft of claim 1, wherein the battery has a power rating of at least 110 kWh and the pump generates a flow rate of fluid of at least 100 LPM.

8. The watercraft of claim 1, wherein the battery includes an enclosure and a plurality of cells.

9. The watercraft of claim 1, wherein the battery is a first battery and the watercraft further includes a second battery electrically coupled to the electric drive; and wherein the outlet channel is fluidly coupled to the pump, the first battery, and the second battery.

10. The watercraft of claim 9, further comprising a first valve positioned in the outlet channel between the pump and the first battery, and a second valve positioned in the outlet channel between the pump and the second battery.

11. The watercraft of claim 10, wherein the first valve and the second valve are electrically actuated.

12. The watercraft of claim 10, wherein the first valve is open to flood the first battery while the second valve is closed and the second battery is operational.

13. A watercraft comprising:
a hull;
an electric drive;
a battery electrically coupled to the electric drive;
an intake aperture formed in the hull;
an intake channel positioned between the intake aperture and the battery;
a first passive valve positioned in the intake channel;
an actuated valve positioned in the intake channel;
a discharge aperture formed in the hull;
a discharge channel positioned between the battery and the discharge aperture; and
a second passive valve positioned in the discharge channel.

14. The watercraft of claim 13, wherein the intake aperture is positioned in a bottom portion of the hull and the discharge aperture is positioned in a side portion of the hull.

15. The watercraft of claim 13, wherein the first passive valve is positioned between the actuated valve and the battery.

16. The watercraft of claim 13, wherein the first passive valve is a burst disc.

17. A method comprising:
detecting a failure in a battery positioned within a watercraft;
opening a flow channel in fluid communication with the battery;
moving water external to the watercraft through the flow channel and into the battery to cool the battery and create heated water; and
draining heated water out of the battery.

18. The method of claim 17, wherein detecting the failure in the battery includes determining a temperature in the battery is over a threshold temperature.

19. The method of claim 17, wherein detecting the failure in the battery includes determining a voltage of the battery is outside of a threshold range.

20. The method of claim 17, further including activating a pump; wherein the pump moves water into the battery.

21. The method of claim 20, wherein activating the pump is in response to receiving a user input or automatic in response to detecting the failure.

22. The method of claim 17, wherein opening the flow channel is in response to detecting the failure.

23. The method of claim 17, further including opening a release in response to a pressure within the battery exceeding a threshold pressure.

24. The method of claim 17, wherein draining heated water out of the battery includes moving heated water to a bilge area of the watercraft or discharging heated water from the watercraft.

25. The method of claim 17, wherein the battery is a first battery and the method further includes energizing an electric drive powered by a second battery.
